(19) United States
(12) Patent Application Publication
(10) Pub. No.: US 2025/0360732 A1
(43) Pub. Date: Nov. 27, 2025

(54) IMAGE FORMATION SYSTEM CAPABLE OF CHANGING IMAGE FORMING SURFACE OF SHEET IN DOUBLE-SIDED PRINTING

(71) Applicant: KYOCERA Document Solutions Inc., Osaka (JP)

(72) Inventor: Hiroki TAKEHANA, Osaka (JP)

(73) Assignee: KYOCERA Document Solutions Inc., Osaka (JP)

(21) Appl. No.: 19/211,192

(22) Filed: May 18, 2025

(30) Foreign Application Priority Data
May 21, 2024 (JP) 2024-082799

(51) Int. Cl. B41J 13/00; B41J 3/60

(52) U.S. Cl. CPC B41J 13/009; B41J 3/60

(57) ABSTRACT

The controller conducts either one of: a first conveyance manner to allow the image forming apparatus to form an image of an N-th page on the upward facing front side of the sheet and then form an image of an (N+1)-th page on the upward facing back side of the sheet after being turned over and conveyed the sheet, with the front side having the image of the N-th page facing downward, to be ejected; and a second conveyance manner to allow the image forming apparatus to form the image of the (N+1)-th page on the upward facing front side of the sheet and then form the image of the N-th page on the upward facing back side of the sheet after being turned over and conveyed the sheet, with the back side having the image of the N-th page facing upward, to be ejected.

### INCORPORATION BY REFERENCE

This application claims priority to Japanese Patent Application No. 2024-082799 filed on May 21, 2024, the entire contents of which are incorporated by reference herein.

### BACKGROUND

The present disclosure relates to image formation systems including: an image forming apparatus that forms an image on a sheet; and a sheet conveyance device that receives and conveys the sheet having been conveyed from the image forming apparatus.

Ink-jet image forming apparatuses are known that form an image on a sheet by ejecting ink to the sheet. For example, there is a generally known ink-jet recording apparatus including: a conveyance path along which a sheet is conveyed from a cassette via a recording head to a sheet output tray and thus ejected to the sheet output tray; and another conveyance path along which the sheet is conveyed reversely from the sheet output tray to turn the sheet over and conveyed to the recording head again. This general ink-jet recording apparatus can appropriately selectively use the two conveyance paths to convey a sheet, thus preforming: face-down sheet ejection in which are and the sheet is ejected with the front side down (referred to as face-down) to the sheet output tray; face-up sheet ejection in which the sheet is ejected with the front side up (referred to as face-up) to the sheet output tray; and double-sided recording of the sheet.

### SUMMARY

A technique improved over the aforementioned technique is proposed as one aspect of the present disclosure.

An image formation system according to an aspect of the present disclosure includes an image forming apparatus, a sheet conveyance device, and a controller. The image forming apparatus forms an image on an upward facing side of a sheet and then conveys the sheet externally from the image forming apparatus. The sheet conveyance device receives the sheet conveyed from the image forming apparatus and includes: a first mechanism that conveys the received sheet, without turning the sheet over, to eject the sheet from the sheet conveyance device; and a second mechanism that conveys the received sheet back toward the image forming apparatus without turning the sheet over. The controller includes a processor and, in forming images on a front side and a back side of a sheet upon execution of a control program by the processor, conducts sheet conveyance in either one of: a first conveyance manner to allow the image forming apparatus to form an image of an N-th page (where N is an odd number) on the upward facing front side of the sheet and then form an image of an (N+1)-th page on the upward facing back side of the sheet after being turned over and conveyed back to the image forming apparatus, and allow the sheet, with the front side having the image of the N-th page facing downward, to be conveyed from the image forming apparatus to the sheet conveyance device and ejected through the first mechanism from the sheet conveyance device; and a second conveyance manner to allow the image forming apparatus to form the image of the (N+1)-th page on the upward facing front side of the sheet and then form the image of the N-th page on the upward facing back side of the sheet after being turned over and conveyed back to the image forming apparatus, and allow the sheet, with the back side having the image of the N-th page facing upward, to be conveyed from the image forming apparatus to the sheet conveyance device and ejected through the first mechanism from the sheet conveyance device.

### BRIEF DESCRIPTION OF THE DRAWINGS

FIG. 1 is a cross-sectional view showing a schematic structure of an image formation system.

FIG. 2 is a block diagram showing the configuration of a control system in the image formation system.

FIG. 3 is a cross-sectional view schematically showing a sheet conveyance device.

FIGS. 4A and 4B are views showing two types of orders of conveyance paths in which sheets pass when conveyed and turned over in the sheet conveyance device and ejected from the sheet conveyance device.

FIGS. 5A and 5B are views showing two types of orders of conveyance paths in which sheets pass when conveyed in the sheet conveyance device and turned from the sheet conveyance device back to the image forming apparatus.

FIG. 6 is a chart showing the states of five sheets where images of five pages are printed on the front sides of the five sheets in a forward printing order or a reverse printing order and the sheets are ejected face-up or face-down to a sheet output tray.

FIG. 7 is a chart showing the states of five sheets where images of five pages are printed on both sides of the five sheets in a forward printing order or a reverse printing order and the sheets are ejected face-up or face-down to a sheet output tray.

FIG. 8 is a flowchart showing the control of single-sided printing or double-sided printing, sheet ejection in a face-up manner or face-down manner, and sheet conveyance according to the forward or reverse printing order.

### DETAILED DESCRIPTION

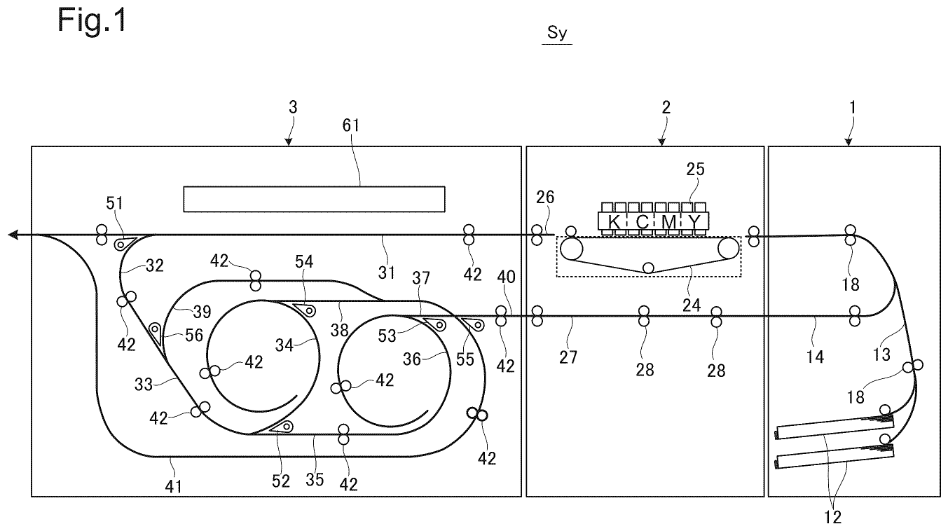

Hereinafter, a description will be given of one embodiment of the present disclosure with reference to the drawings. FIG. 1 is a cross-sectional view schematically showing the structure of an image formation system Sy according to this embodiment. As shown in FIG. 1, the image formation system Sy includes a sheet feeder 1, an image forming apparatus 2, and a sheet conveyance device 3. The sheet feeder 1 feeds a sheet to the image forming apparatus 2. The image forming apparatus 2 receives the sheet from the sheet feeder 1 and forms an image on the sheet. The sheet conveyance device 3 receives the sheet from the image forming apparatus 2 and conveys the sheet to eject it to a sheet output tray or conveys the sheet to the image forming apparatus 2 in order to return it to the sheet feeder 1.

The sheet feeder 1 includes a plurality of sheet feed cassettes 12 each containing a plurality of sheets, a sheet-feeding conveyance path 13, a reversing conveyance path 14, and a plurality of conveyance rollers 18 that convey a sheet along the sheet-feeding conveyance path 13 or the reversing conveyance path 14. The sheet-feeding conveyance path 13 is used to convey a sheet pulled out of one of the sheet feed cassettes 12 to the image forming apparatus 2. The reversing conveyance path 14 receives a sheet returned through the image forming apparatus 2 to the sheet feeder 1 and is used to turn the sheet over and convey it to the image forming apparatus 2 again.

The image forming apparatus 2 includes: a conveying belt 24 that receives the sheet from the sheet feeder 1 and conveys it; an image forming device 25 that forms an image on the sheet; a conveyance path 26 along which the sheet is conveyed to the sheet conveyance device 3; a conveyance path 27 which receives the sheet returned from the sheet conveyance device 3 back to the image forming apparatus 2 and along which the received sheet is conveyed to the sheet feeder 1; and a plurality of conveyance rollers 28 that convey the sheet along the conveyance paths 26, 27.

The image forming device 25 forms an image on a sheet using an ink-jet system. The image forming device 25 includes ink cartridges, pumps, heads, nozzles, and electrodes. The ink cartridges contain, as an example, individual differently colored inks of Y (yellow), M (magenta), C (cyan), and K (black). Each of the pumps supplies ink from the associated ink cartridge to the associated head. In each of the heads, a large number of nozzles are arranged to form pixels. Based on image data, the head is supplied with the ink of the associated color indicated by the image data from the associated ink cartridge. The nozzles of each head eject the ink toward the sheet. Each of the electrodes is composed of a charging electrode and a biasing electrode. The charging electrode electrically charges the ink ejected from the nozzles. The biasing electrode controls the direction of flight of the charged ink.

The sheet conveyance device 3 includes: a main conveyance path 31 which receives a sheet having been conveyed through the conveyance path 26 in the image forming apparatus 2 and along which the received sheet is conveyed; a branch conveyance path 32 branched from the main conveyance path 31; a second connection conveyance path 33 connected to the branch conveyance path 32; a second drum-shaped conveyance path 34 and a first connection conveyance path 35 both branched from the second connection conveyance path 33, a first drum-shaped conveyance path 36 connected to the first connection conveyance path 35; a first switchback conveyance path 37 branched from the first drum-shaped conveyance path 36; a second switchback conveyance path 38 branched from the second drum-shaped conveyance path 34; a third connection conveyance path 39 connecting the second connection conveyance path 33 to the second switchback conveyance path 38; a relay conveyance path 40 connecting the first switchback conveyance path 37 and the second switchback conveyance path 38 to the conveyance path 27 in the image forming apparatus 2; and a sub-conveyance path 41 connecting the first switchback conveyance path 37 and the second switchback conveyance path 38 to the main conveyance path 31.

The sheet conveyance device 3 includes a plurality of conveyance rollers 42 provided along the conveyance paths 31 to 41 to convey a sheet.

The sheet conveyance device 3 includes: a diverting finger 51 provided at a branch point between the main conveyance path 31 and the branch conveyance path 32; a diverting finger 52 provided at a branch point where the second connection conveyance path 33 branches into the second drum-shaped conveyance path 34 and the first connection conveyance path 35; a diverting finger 53 provided at a branch point where the first switchback conveyance path 37 branches off from the first drum-shaped conveyance path 36; a diverting finger 54 provided at a branch point where the second switchback conveyance path 38 branches off from the second drum-shaped conveyance path 34; a diverting finger 55 provided at a branch point where the first switchback conveyance path 37 and the second switchback conveyance path 38 branch into the relay conveyance path 40 and the sub-conveyance path 41; and a diverting finger 56 provided at a branch point where the third connection conveyance path 39 branches off from the second connection conveyance path 33.

The sheet conveyance device 3 includes a heat generator 61 disposed above the main conveyance path 31. The heat generator 61 applies infrared rays to the top surface of a sheet being conveyed through the main conveyance path 31 to prompt drying of ink adhering to the top surface of the sheet.

In forming images on upward facing front sides (the front sides; the same applies hereafter) of sheets by the image forming apparatus 2, an image is formed on the front side of each sheet and the sheet is conveyed through the conveyance path 26 in the image forming apparatus 2 to the main conveyance path 31 in the sheet conveyance device 3. When receiving the sheet, the sheet conveyance device 3 appropriately changes the positions of the diverting fingers 51 to 56 to convey the sheet through some conveyance paths and ejects the sheet face-up (in a state where a first side thereof with an image first formed faces upward) or face-down (in a state where the first side thereof with an image first formed faces downward) through the main conveyance path 31.

In forming images on both sides of each of sheets by the image forming apparatus 2, an image is first formed on the upward facing front side of the sheet and the sheet is conveyed through the conveyance path 26 in the image forming apparatus 2 to the main conveyance path 31 in the sheet conveyance device 3. When receiving the sheet, the sheet conveyance device 3 appropriately changes the positions of the diverting fingers 51 to 56 to convey the sheet through some conveyance paths to the relay conveyance path 40 and then convey the sheet through the relay conveyance path 40 to the conveyance path 27 in the image forming apparatus 2. The sheet is then conveyed through the conveyance path 27 in the image forming apparatus 2 to the reversing conveyance path 14 in the sheet feeder 1.

The sheet feeder 1 conveys the sheet through the reversing conveyance path 14 to turn the sheet over and then conveys the sheet to the image forming apparatus 2 again.

In the image forming apparatus 2, the sheet is conveyed to the image forming device 25, an image is formed on the upward facing back side of the sheet by the image forming device 25, and the sheet with images thus formed on both sides thereof is conveyed through the conveyance path 26 toward the main conveyance path 31 in the sheet conveyance device 3.

When the sheet is conveyed to the main conveyance path 31, the sheet conveyance device 3 ejects the sheet face-up (with the first side facing upward) or face-down (with the first side facing downward) through the main conveyance path 31 to the sheet output tray.

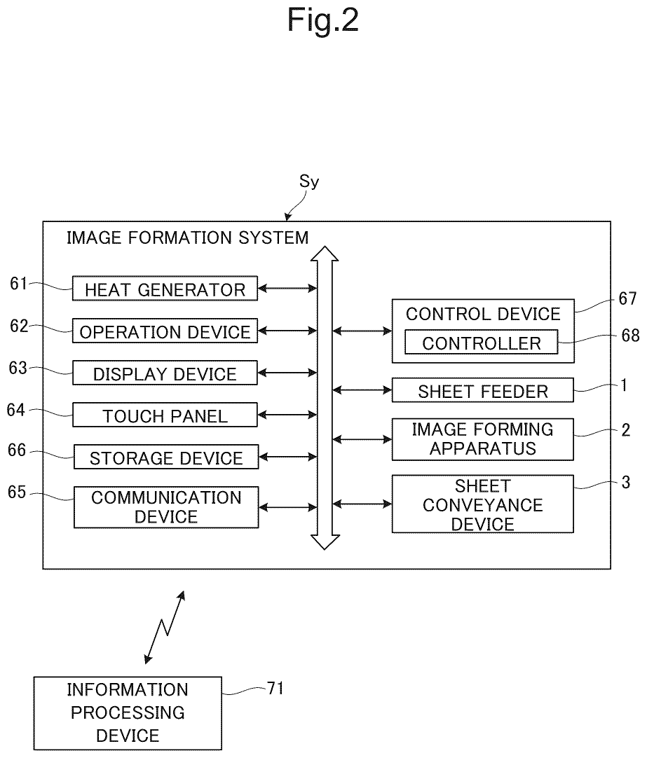

FIG. 2 is a block diagram showing the configuration of a control system in the image formation system Sy. As shown in FIG. 2, the image formation system Sy includes the sheet feeder 1, the image forming apparatus 2, the sheet conveyance device 3, the heat generator 61, an operation device 62, a display device 63, a touch panel 64, a communication device 65, a storage device 66, and a control device 67. These components can transmit and receive data or signals to and from each other via a bus.

The operation device 62 includes hardware keys, including numeric keys, an Enter key, and a Start key.

The display device 63 is formed of a liquid crystal display (LCD), an organic EL (organic light-emitting diode (OLED)) display or the like.

The touch panel 64 is disposed over the screen of the display device 63. The touch panel 64 detects a touch on the touch panel 64 with a user's finger or the like, together with a point of the touch, and outputs a detection signal indicating the coordinate of the point of touch to a controller 68 of the control device 67. Thus, the user can make an operation (a gesture) through the touch panel 43 on a GUI (graphical user interface) or the like being displayed on the screen of the display device 63. Therefore, the touch panel 64 functions as an operation device to which a user's gesture on the screen of the display device 63 is to be input.

The communication device 65 is a communication interface including a communication module, such as a LAN (local area network) chip. The communication device 65 is connected via a network (such as an intranet) to an external information processing device 71 and performs data communications with the information processing device 71. For example, the information processing device 71 is a DFE (digital front end) device and sends image data representing an image to the communication device 65 of the image formation system Sy.

The storage device 66 is a large-capacity storage device, such as an SSD (solid state drive) or an HDD (hard disk drive). The storage device 66 stores various types of application programs and various types of data.

The control device 67 is constituted by a processor, a RAM (random access memory), a ROM (read only memory), and so on. The processor is, for example, a CPU (central processing unit), an ASIC (application specific integrated circuit) or an MPU (micro processing unit). When a control program stored in the above ROM or the storage device 66 is executed by the processor, the control device 67 functions as the controller 68.

The control device 67 governs the control of the sheet feeder 1, the image forming apparatus 2, and the sheet conveyance device 3. The control device 67 is connected to the heat generator 61, the operation device 62, the display device 63, the touch panel 64, the communication device 65, and the storage device 66 and performs control on each of these components and signal or data transfer to and from each of the components. The controller 68 is provided, for example, in the interior of the image forming apparatus 2. The controller 68 serves as a processor that executes various types of processing. For example, when the communication device 65 receives image data sent from the information processing device 71, the controller 68 controls the sheet feeder 1 to allow the sheet feeder 1 to convey a sheet to the image forming apparatus 2. The controller 68 allows the image forming apparatus 2 to form an image represented by the received image data on the sheet and convey the sheet from the image forming apparatus 2 to the sheet conveyance device 3.

In doing so, based on a user's operation on the operation device 62 (for example, a gesture on a GUI displayed on the screen of the display device 63), the operation device 62 accepts, for example, an instruction to do single-sided printing or double-side printing on the sheet and eject the sheet face-up or face-down. The controller 68 performs controls in accordance with the instruction accepted through the touch panel 64 by the operation device 62.

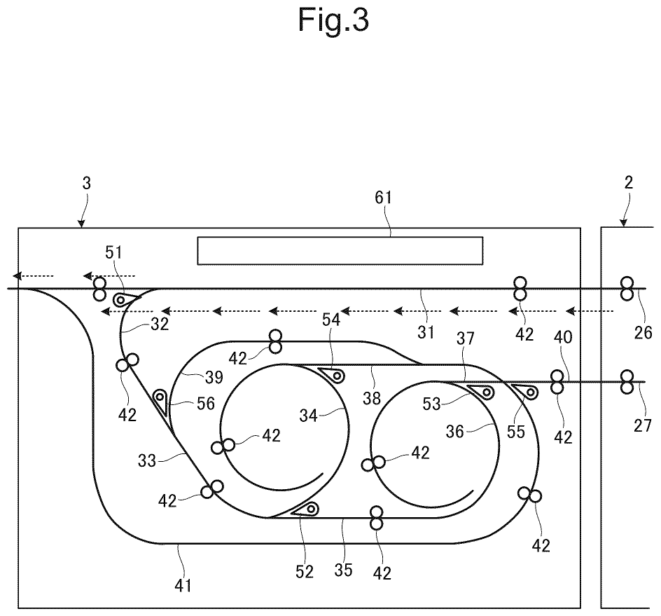

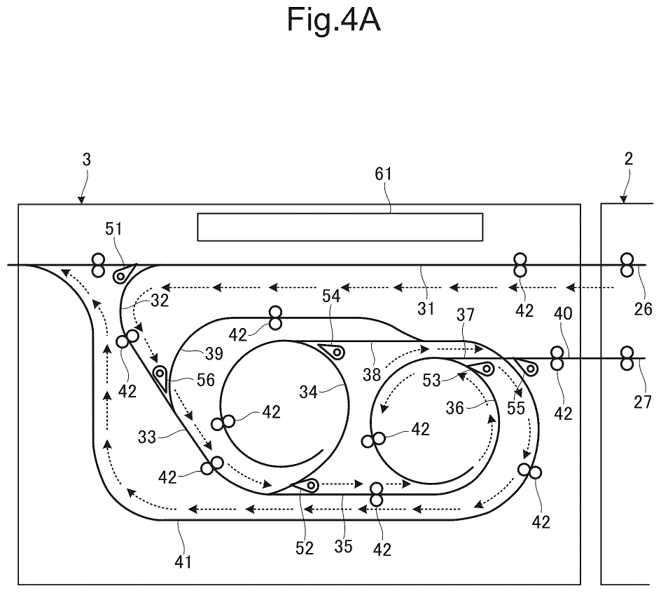

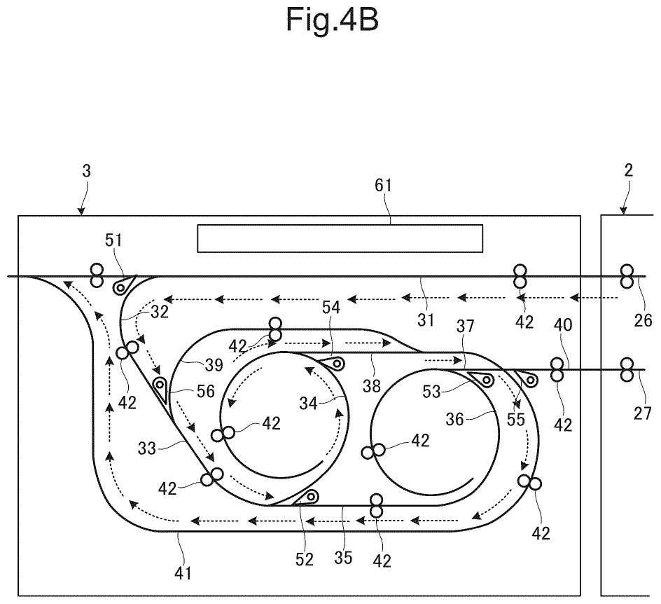

For example, when the user gives an instruction to do single-sided printing on sheets and eject the sheets face-down, the controller 68 controls the sheet feeder 1 based on the instruction to allow the sheet feeder 1 to convey each sheet from the sheet feeder 1 to the image forming apparatus 2 and controls the image forming apparatus 2 based on the instruction to allow the image forming apparatus 2 to form an image on the upward facing front side of the sheet and convey the sheet from the image forming apparatus 2 to the sheet conveyance device 3. Furthermore, the controller 68 controls the drive of motors operable to rotate the respective conveyance rollers 42 of the sheet conveyance device 3, the drive of actuators operable to move the respective diverting fingers 51 to 57 of the sheet conveyance device 3 back and forth to allow them to convey the sheet in any one of routes shown in FIGS. 3, 4A, and 4B and eject the sheet face-down or face-up through the main conveyance path 31 from the sheet conveyance device 3.

FIGS. 4A and 4B show two types of orders of conveyance paths in which sheets with images printed on the upward facing front sides are conveyed from the image forming apparatus 2 into the sheet conveyance device 3 and ejected face-down (with the first sides (the front sides in this case) facing downward) from the sheet conveyance device 3. In FIG. 4A, when each of sheets with images printed on the upward facing front sides is conveyed from the conveyance path 26 in the image forming apparatus 2 to the main conveyance path 31, the sheet is conveyed in the order of the main conveyance path 31, the diverting finger 51, the branch conveyance path 32, the second connection conveyance path 33, the diverting finger 52, the first connection conveyance path 35, and then the first drum-shaped conveyance path 36 and temporarily stopped, at which time the trailing end of the sheet has passed through the diverting finger 53. Subsequently, when the conveyance roller 42 in the first drum-shaped conveyance path 36 is reversely rotated, the sheet is conveyed in the reverse direction (referred to as “conveyed in a switchback manner”). Specifically, the sheet is conveyed in the order of the first drum-shaped conveyance path 36, the diverting finger 53, the first switchback conveyance path 37, the diverting finger 55, and then the sub-conveyance path 41, thus turned over, and ejected face-down through the sub-conveyance path 41 and the main conveyance path 31 from the sheet conveyance device 3.

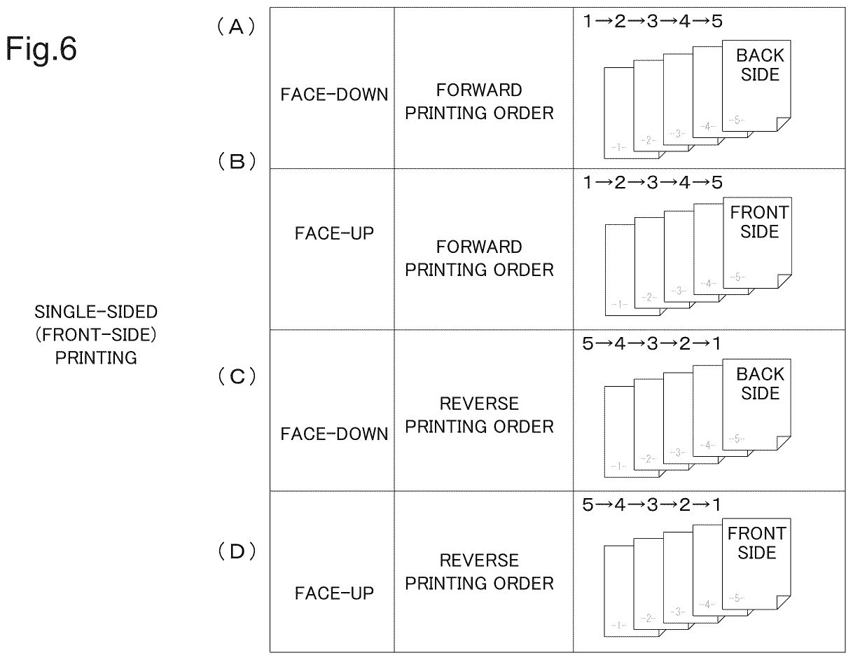

In FIG. 4B, when each of the sheets is conveyed face-up from the conveyance path 26 in the image forming apparatus 2 to the main conveyance path 31, the sheet is conveyed in the order of the main conveyance path 31, the diverting finger 51, the branch conveyance path 32, the second connection conveyance path 33, the diverting finger 52, and then the second drum-shaped conveyance path 34 and temporarily stopped, at which time the trailing end of the sheet has passed through the diverting finger 54. Subsequently, when the conveyance roller 42 in the second drum-shaped conveyance path 34 is reversely rotated, the sheet is conveyed in a switchback manner. Specifically, the sheet is conveyed in the order of the second drum-shaped conveyance path 34, the diverting finger 54, the second switchback conveyance path 38, the diverting finger 55, and then the sub-conveyance path 41, thus turned over, and ejected face-down through the sub-conveyance path 41 and the main conveyance path 31 from the sheet conveyance device 3 (see (A) and (C) in FIG. 6).

FIG. 3 shows the order of conveyance paths in which sheets with images printed on the upward facing front sides are conveyed from the image forming apparatus 2 into the sheet conveyance device 3 and ejected face-up (with the first sides (the front sides in this case) facing upward) from the sheet conveyance device 3. In FIG. 3, when each of the sheets is conveyed face-up from the conveyance path 26 in the image forming apparatus 2 to the main conveyance path 31, the sheet is conveyed through the main conveyance path 31 and directly ejected from the sheet conveyance device 3 (see (B) and (D) in FIG. 6).

In printing images only on the front sides of sheets as just described, in the case of sheet ejection in a face-up manner, the controller 68 allows the sheets with the printed front sides facing upward to be conveyed through the main conveyance path 31 and directly ejected from the sheet conveyance device 3 as shown in FIG. 3. In the case of sheet ejection in a face-down manner, the controller 68 allows the sheets with the printed front sides facing upward to be turned over using the conveyance route shown in FIG. 4A or FIG. 4B and ejected face-down (with the first sides (the front sides in this case) facing downward) through the main conveyance path 31 from the sheet conveyance device 3.

In the sheet conveyance device 3, the sheets are alternately conveyed to the first drum-shaped conveyance path 36 and the second drum-shaped conveyance path 34 by interlocking both the drum-shaped conveyance paths 36, 34. As a result, as compared to the case where only the first drum-shaped conveyance path 36 is operated, the job throughput per unit time can be increased and, thus, high productivity can be achieved. Furthermore, since the first drum-shaped conveyance path 36 and the second drum-shaped conveyance path 34 for use in shunting sheets have a drum-like shape, the sheet conveyance device 3 can be reduced in size as compared to the case where linear conveyance paths for use to shunt sheets are provided.

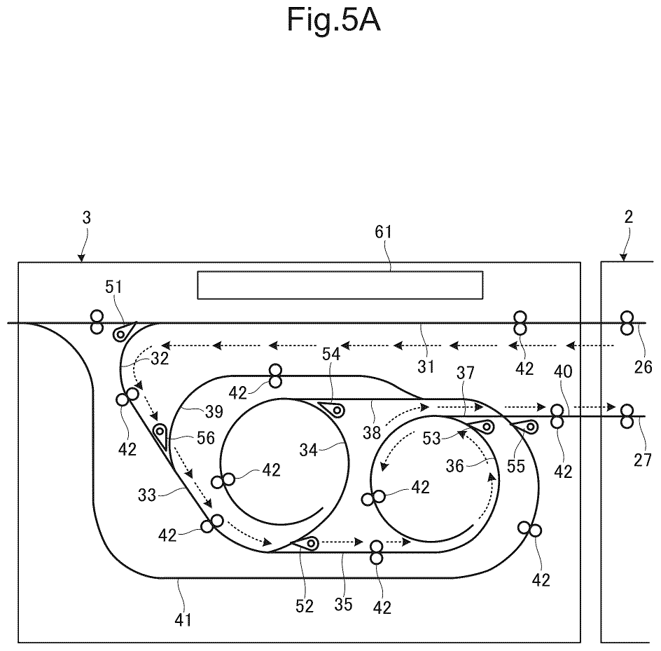

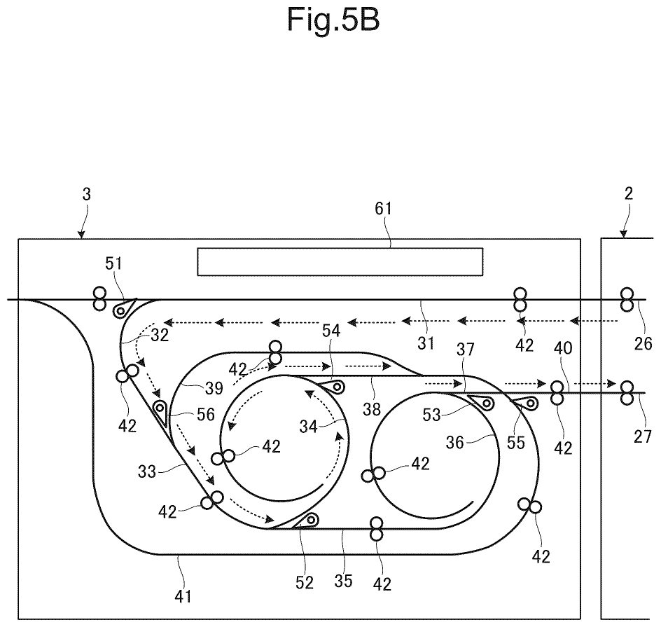

On the other hand, when the user gives an instruction to do double-sided printing on sheets and eject the sheets face-down, the controller 68 controls the sheet feeder 1 based on the instruction to allow the sheet feeder 1 to convey each sheet from the sheet feeder 1 to the image forming apparatus 2 and controls the image forming apparatus 2 based on the instruction to allow the image forming apparatus 2 to form an image on the upward facing front side of the sheet and convey the sheet from the image forming apparatus 2 to the sheet conveyance device 3. Furthermore, the controller 68 controls the drive of the motors operable to rotate the respective conveyance rollers 42 of the sheet conveyance device 3, the drive of the actuators operable to move the respective diverting fingers 51 to 57 of the sheet conveyance device 3 back and forth to allow them to convey the sheet via some conveyance paths to the relay conveyance path 40 as shown in FIG. 5A or 5B and convey the sheet from the relay conveyance path 40 through the conveyance path 27 in the image forming apparatus 2 to the reversing conveyance path 14 in the sheet feeder 1.

In FIG. 5A, when each of sheets having images first printed on the upward facing front sides according to the instruction to do double-sided printing and eject them face-down is conveyed from the conveyance path 26 in the image forming apparatus 2 to the main conveyance path 31, the sheet is conveyed in the order of the main conveyance path 31, the diverting finger 51, the branch conveyance path 32, the second connection conveyance path 33, the diverting finger 52, the first connection conveyance path 35, and then the first drum-shaped conveyance path 36 and temporarily stopped, at which time the trailing end of the sheet has passed through the diverting finger 53. Subsequently, when the conveyance roller 42 in the first drum-shaped conveyance path 36 is reversely rotated, the sheet is conveyed in a switchback manner. Specifically, the sheet is conveyed in the order of the first drum-shaped conveyance path 36, the diverting finger 53, the first switchback conveyance path 37, the diverting finger 55, and then the relay conveyance path 40, and then conveyed, with the front side facing upward, from the relay conveyance path 40 through the conveyance path 27 in the image forming apparatus 2 to the reversing conveyance path 14 in the sheet feeder 1.

In FIG. 5B, when each of sheets having images first printed on the upward facing front sides according to the instruction to do double-sided printing and eject them face-down is conveyed from the conveyance path 26 in the image forming apparatus 2 to the main conveyance path 31, the sheet is conveyed in the order of the main conveyance path 31, the diverting finger 51, the branch conveyance path 32, the second connection conveyance path 33, the diverting finger 52, and then the second drum-shaped conveyance path 34 and temporarily stopped, at which time the trailing end of the sheet has passed through the diverting finger 54. Subsequently, when the conveyance roller 42 in the second drum-shaped conveyance path 34 is reversely rotated, the sheet is thus conveyed in a switchback manner. Specifically, the sheet is conveyed in the order of the second drum-shaped conveyance path 34, the diverting finger 54, the second switchback conveyance path 38, the diverting finger 55, and then the relay conveyance path 40, and then conveyed, with the front side facing upward, from the relay conveyance path 40 through the conveyance path 27 in the image forming apparatus 2 to the reversing conveyance path 14 in the sheet feeder 1.

When, after the sheet conveyance shown in FIG. 5A or 5B, the sheet is conveyed from the conveyance path 27 in the image forming apparatus 2 to the reversing conveyance path 14 in the sheet feeder 1, the sheet is turned over in the reversing conveyance path 14 and then conveyed to the image forming apparatus 2 again. The image forming apparatus 2 forms an image on the sheet with the back side facing upward and then conveys the sheet with images printed on both sides from the image forming apparatus 2 to the sheet conveyance device 3.

Thereafter, the sheet is conveyed through the main conveyance path 31 and ejected as it is through the main conveyance path 31 as shown in FIG. 3. Thus, the sheet can be ejected face-down.

In another case where the user inputs to the operation device 62 an instruction to do double-sided printing on sheets and eject the sheets face-up, it may be possible that the controller 68 controls the sheet feeder 1, the image forming apparatus 2, and the sheet conveyance device 3 based on the instruction to allow the image forming apparatus 2 to form an image on the front side (the first side) of each sheet, allow the sheet conveyance device 3 to turn the sheet over in either one of the conveyance routes shown in FIGS. 5A and 5B, allow the image forming apparatus 2 to form an image on the back side (the second side) of the sheet again, and allow the sheet conveyance device 3 to further turn the sheet over using either one of the conveyance routes shown in FIGS. 4A and 4B and then eject the sheet through the sub-conveyance path 41. Thus, the sheet is ejected face-up.

However, regarding the sheets subjected to double-sided printing, if the conveyance route along which the sheets pass after images are formed on both sides thereof is long, a sheet jam or the like may be highly likely to occur, for example, because both sides of the sheets are wet with ink. Therefore, it is desirable to shorten the conveyance route of the sheets with images formed on both sides thereof to quickly eject the sheets.

To this end, in this embodiment, when the user gives an instruction to do double-sided printing on sheets and eject the sheets face-up, the controller 68 allows the image forming apparatus 2 to first form an image of an (N+1)-th page on the upward facing front side of each sheet and convey the sheet from the image forming apparatus 2 to the sheet conveyance device 3, allows the sheet conveyance device 3 to convey the sheet from the relay conveyance path 40 to the conveyance path 27 in the image forming apparatus 2 as shown in FIG. 5A or 5B, and allows the image forming apparatus 2 to return the sheet through the conveyance path 27 to the reversing conveyance path 14 in the sheet feeder 1, and allows the sheet feeder 1 to turn the sheet over in the reversing conveyance path 14. The controller 68 allows the sheet feeder 1 to convey the sheet to the image forming apparatus 2 again, allows the image forming apparatus 2 to form an image of an N-th page on the back side of the sheet, the back side facing upward at this time, and convey the sheet with images printed on both sides from the image forming apparatus 2 to the sheet conveyance device 3 again, and allows the sheet conveyance device 3 to eject the sheet only through the main conveyance path 31 in the route shown in FIG. 3. In this embodiment, a series of sheet conveyance routes just described is adopted.

As described above, in this embodiment, while the sheet conveyance route shown in FIG. 5A or 5B in which sheets will be ejected face-down ordinarily is adopted, the order of image formation on the front and back sides of an individual sheet is reversed to that in the ordinary manner of ejecting sheets face-down, by first forming an image of an (N+1)-th page on the upward facing front side of the sheet and then forming an image of an N-th page on the upward facing back side of the sheet. Thus, the sheets with images printed on both sides thereof can be ejected in a state equivalent to the ordinary manner of ejecting sheets face-up, i.e., in a state that their first sides with images first formed face upward, only through the main conveyance path 31 without using the sheet conveyance route for turnover shown in FIG. 4A or 4B. As a result, sheet ejection equivalent to the ordinary manner of ejecting sheets face-up can be achieved while the sheet conveyance route of each sheet after images are formed on both sides can be shortened.

When the user operates the operation device 62 to input an instruction not only to do double-sided printing on sheets and eject the sheets face-down or face-up, but also to specify the order of printing to-be-printed images of a plurality of pages on a plurality of recording paper sheets, the controller 68 allows the image forming apparatus 2 to form images according to the specified printing order.

The order of printing images of a plurality of pages includes: a forward order in which the images are formed in the original order of pages indicated by print target data received by the communication device 65 of the image formation system Sy from the information processing device 71; and a reverse order in which the images are formed in the order opposite to the original order of pages. An instruction to select the forward order or the reverse order is input to the operation device 62 by a user's operation and accepted by the controller 68.

When an instruction to do double-sided printing on sheets, eject the sheets face-down, and specify the forward order of printing images of a plurality of pages is input to the operation device 62 by a user's operation, the controller 68 allows the image forming apparatus 2 to form the images in the specified printing order, i.e., in the exact order indicated by the print target data.

In this case, the controller 68 allows the image forming apparatus 2 to form images on each sheet so that the front-side image is located on an N-th page (where N is an odd number) and the back-side image is located on an (N+1)-th page.

The controller 68 allows the sheet feeder 1 to convey each sheet from the sheet feeder 1 to the image forming apparatus 2, allows the image forming device 25 of the image forming apparatus 2 to form an image of an N-th page on the upward facing front side of the sheet, and allows the image forming apparatus 2 to convey the sheet with the image formed thereon toward the sheet conveyance device 3. The controller 68 allows the sheet conveyance device 3 to turn the sheet over in the route shown in FIG. 5A or 5B and convey the sheet back toward the image forming apparatus 2. The controller 68 allows the image forming device 25 of the image forming apparatus 2 to form an image of an (N+1)-th page on the back side of the sheet, the back side facing upward at this time. The controller 68 allows the image forming apparatus 2 to convey the sheet from the image forming apparatus 2 to the sheet conveyance device 3 and allows the sheet conveyance device 3 to eject the sheet in the conveyance route where the sheet passes only through the main conveyance path 31 as shown in FIG. 3.

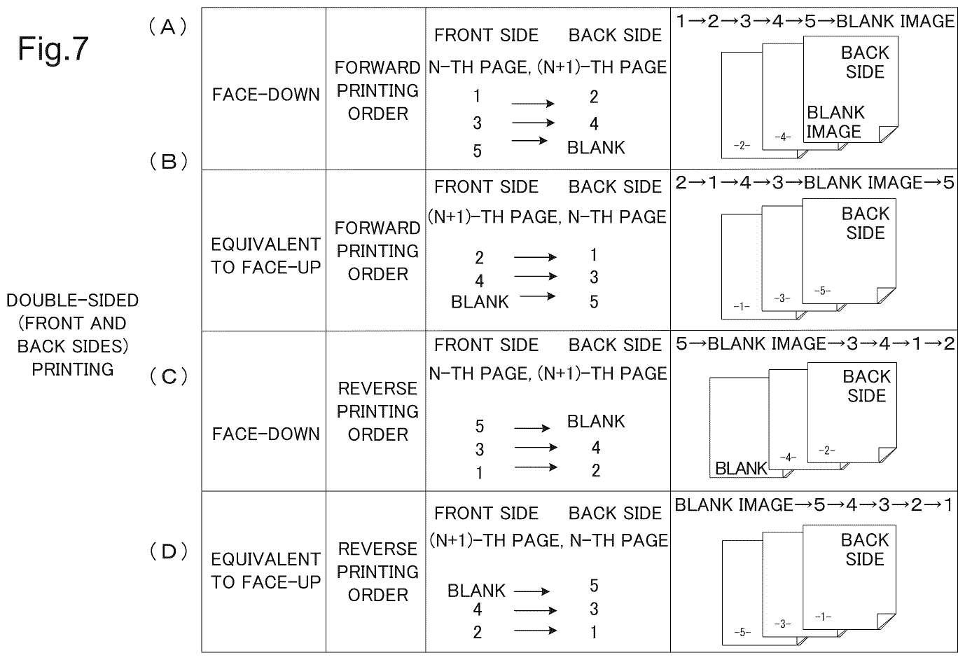

For example, when, as shown in (A) of FIG. 7, printing is done in accordance with an instruction to do double-sided printing for images of five pages, eject sheets face-down, and specify the forward order of printing, the image of the first page is formed on the front side of a first sheet, the image of the second page is formed on the back side of the first sheet, the image of the third page is formed on the front side of a second sheet, the image of the fourth page is formed on the back side of the second sheet, and the image of the fifth page is formed on the front side of a third sheet. In this case, with the front sides of the sheets facing downward and the back sides of the sheets facing upward, the sheets are sequentially ejected through the main conveyance path 31 to the sheet output tray and laid one after another on the sheet output tray. Therefore, the sheets are ejected face-down.

When image formation is done in the printing order indicated by print target data in accordance with an instruction to do double-sided printing on sheets, eject the sheets face-up, and specify the forward order of printing images of a plurality of pages, the controller 68 allows the sheet feeder 1 to convey each sheet from the sheet feeder 1 to the image forming apparatus 2, allows the image forming device 25 of the image forming apparatus 2 to form an image of an (N+1)-th page on the upward facing front side of the sheet, and allows the image forming apparatus 2 to convey the sheet with the image formed thereon toward the sheet conveyance device 3. The controller 68 allows the sheet conveyance device 3 to turn the sheet over in the route shown in FIG. 5A or 5B and convey the sheet back toward the image forming apparatus 2. The controller 68 allows the image forming device 25 of the image forming apparatus 2 to form an image of an N-th page on the back side of the sheet, the back side facing upward at this time. The controller 68 allows the image forming apparatus 2 to convey the sheet from the image forming apparatus 2 to the sheet conveyance device 3 and allows the sheet conveyance device 3 to eject the sheet in the conveyance route where the sheet passes only through the main conveyance path 31 as shown in FIG. 3.

For example, when, as shown in (B) of FIG. 7, printing is done in accordance with an instruction to do double-sided printing for images of five pages, eject sheets face-up, and specify the forward order of printing, the image of the second page is formed on the front side of a first sheet, the image of the first page is formed on the back side of the first sheet, the image of the fourth page is formed on the front side of a second sheet, the image of the third page is formed on the back side of the second sheet, the front side of a third sheet is blank, and the image of the fifth page is formed on the back side of the third sheet. As a result, with the front sides of the sheets facing downward and the back sides of the sheets facing upward, the sheets are sequentially ejected through the main conveyance path 31 to the sheet output tray and laid one after another on the sheet output tray. Therefore, the sheets are ejected with each page facing in the same direction as that in the ordinary manner of ejecting sheets face-up in which the first side faces upward.

When image formation is done in accordance with an instruction to do double-sided printing on sheets, eject the sheets face-down, and specify the reverse order of printing images of a plurality of pages, the controller 68 allows the image forming apparatus 2 to form images on each sheet in the opposite order to the printing order indicated by print target data and with the front-side image on an N-th page (where N is an odd number) and the back-side image on an (N+1)-th page.

In this case, the controller 68 allows the images of the plurality of pages to be formed, in accordance with the instruction to specify the reverse order of printing, in the order of pages reverse to the original order indicated by the print target data. The controller 68 allows the image forming device 25 of the image forming apparatus 2 to form, beginning with an image of the last page of the print target data, an image of an N-th page on the upward facing front side of a sheet, and allows the image forming apparatus 2 to convey the sheet with the image formed thereon toward the sheet conveyance device 3. The controller 68 allows the sheet conveyance device 3 to turn the sheet over in the route shown in FIG. 5A or 5B and convey the sheet back toward the image forming apparatus 2. The controller 68 allows the image forming device 25 of the image forming apparatus 2 to form an image of an (N+1)-th page on the back side of the sheet, the back side facing upward at this time. The controller 68 allows the image forming apparatus 2 to convey the sheet from the image forming apparatus 2 to the sheet conveyance device 3 and allows the sheet conveyance device 3 to eject the sheet in the conveyance route where the sheet passes only through the main conveyance path 31 as shown in FIG. 3.

For example, when, as shown in (C) of FIG. 7, printing is done in accordance with an instruction to do double-sided printing for images of five pages, eject sheets face-down, and specify the reverse order of printing, the image of the fifth page is formed on the front side of a first sheet, the back side of the first sheet is blank, the image of the third page is formed on the front side of a second sheet, the image of the fourth page is formed on the back side of the second sheet, the image of the first page is formed on the front side of a third sheet, and the image of the second page is formed on the back side of the third sheet. In this case, with the front sides of the sheets facing downward and the back sides of the sheets facing upward, the sheets are sequentially ejected through the main conveyance path 31 to the sheet output tray and laid one after another on the sheet output tray. Therefore, the sheets are ejected face-down.

When image formation is done in accordance with an instruction to do double-sided printing on sheets, eject the sheets face-up, and specify the reverse order of printing images of a plurality of pages, the controller 68 allows the image forming apparatus 2 to form images on each sheet in the opposite order to the printing order indicated by print target data and with the front-side image on an N-th page (where N is an odd number) and the back-side image on an (N+1)-th page.

In this case, the controller 68 allows the images of the plurality of pages to be formed, in accordance with the instruction to specify the reverse order of printing, in the order of pages reverse to the original order indicated by the print target data. The controller 68 allows the image forming device 25 of the image forming apparatus 2 to form, beginning with an image of the last page of the print target data, an image of an (N+1)-th page on the upward facing front side of a sheet, and allows the image forming apparatus 2 to convey the sheet with the image formed thereon toward the sheet conveyance device 3. The controller 68 allows the sheet conveyance device 3 to turn the sheet over in the route shown in FIG. 5A or 5B and convey the sheet back toward the image forming apparatus 2. The controller 68 allows the image forming device 25 of the image forming apparatus 2 to form an image of an N-th page on the back side of the sheet, the back side facing upward at this time. The controller 68 allows the image forming apparatus 2 to convey the sheet from the image forming apparatus 2 to the sheet conveyance device 3 and allows the sheet conveyance device 3 to eject the sheet in the conveyance route where the sheet passes only through the main conveyance path 31 as shown in FIG. 3.

For example, when, as shown in (D) of FIG. 7, printing is done in accordance with an instruction to do double-sided printing for images of five pages, eject sheets face-up, and specify the reverse order of printing, the front side of a first sheet is blank, the image of the fifth page is formed on the back side of the first sheet, the image of the fourth page is formed on the front side of a second sheet, the image of the third page is formed on the back side of the second sheet, the image of the second page is formed on the front side of a third sheet, and the image of the first page is formed on the back side of the third sheet. In this case, with the front sides of the sheets facing downward and the back sides of the sheets facing upward, the sheets are sequentially ejected through the main conveyance path 31 to the sheet output tray and laid one after another on the sheet output tray. Therefore, the sheets are ejected with each page facing in the same direction as that in the ordinary manner of ejecting sheets face-up in which the first side faces upward.

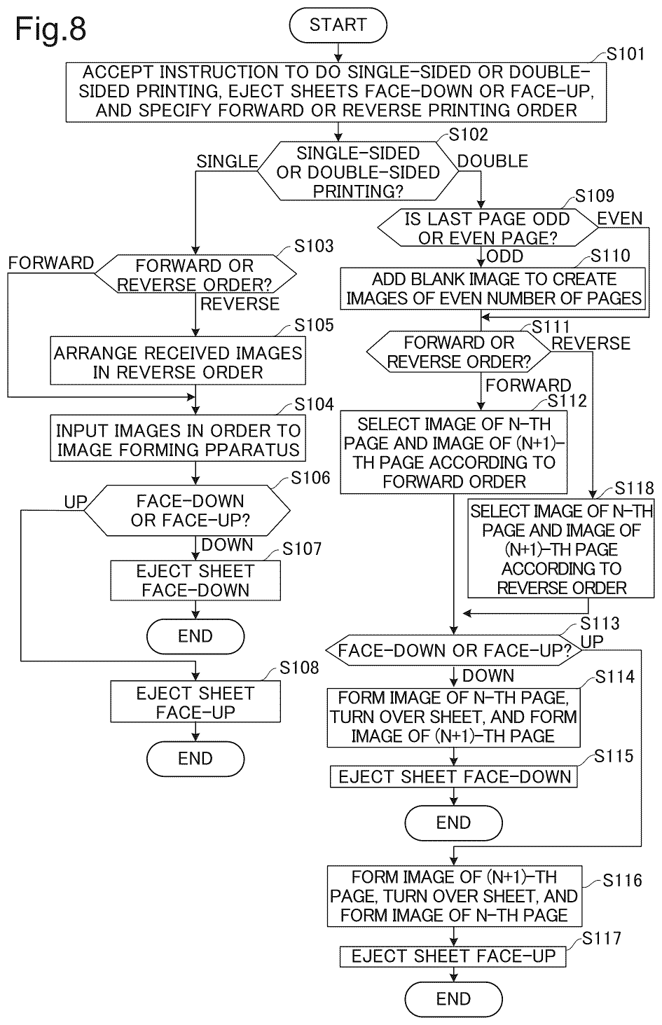

Next, a description will be given, in organized way, of image formation and sheet conveyance done in accordance with an instruction to do single-sided printing or double-sided printing on sheets, eject the sheets face-down or face-up, and specify the forward order of printing or the reverse order of printing, with reference to the flowchart shown in FIG. 8.

The controller 68 accepts through the operation device 62 a user's instruction to do single-sided printing or double-sided printing on sheets, eject the sheets face-down or face-up, and specify the forward order of printing or the reverse order of printing (step S101).

When the controller 68 determines that the accepted instruction indicates single-sided printing (“Single” in step S102), the controller 68 determines whether the accepted instruction indicates the forward order of printing or the reverse order of printing (step S103).

When determining that the accepted instruction indicates the forward order of printing (“Forward” in step S103), the controller 68 allows the image forming device 25 to form images, which are represented by print target data sent from the information processing device 71 and received by the communication device 65 of the image formation system Sy, on sheets in the original order of pages indicated by the print target data (step S104).

When determining that the accepted instruction indicates the reverse order of printing (“Reverse” in step S103), the controller 68 rearranges the pages consisting of individual to-be-printed images from the original order of pages indicated by the print target data sent from the information processing device 71 and received by the communication device 65 of the image formation system Sy to the order reverse to the original order (step S105) and allows the image forming device 25 to form the images represented by the print target data on sheets in the reverse order of printing (step S104).

The image forming apparatus 2 forms the images represented by the print target data on the individual sheets and conveys the sheets to the sheet conveyance device 3.

The controller 68 determines whether the accepted instruction indicates face-down sheet ejection or face-up sheet ejection (step S106). When determining that the accepted instruction indicates face-down sheet ejection (“Down” in step S106), the controller 68 allows the sheet conveyance device 3 to convey the sheets in the route shown in FIG. 4A or 4B and eject the sheets face-down through the main conveyance path 31 from the sheet conveyance device 3 (step S107).

When determining that the accepted instruction indicates face-up sheet ejection (“Up” in step S106), the controller 68 allows the sheet conveyance device 3 to convey the sheets in the route shown in FIG. 3 and eject the sheets face-up through the main conveyance path 31 from the sheet conveyance device 3 (step S108).

On the other hand, when the controller 68 determines that the accepted instruction indicates double-sided printing (“Double” in step S102), the controller 68 determines whether the last page of the print target data is an even page or an odd page (step S109). When determining that the last page is an odd page (“Odd” in step S109), the controller 68 adds a piece of image data representing a blank image after a piece of image data representing the image of the last page of the print target data to create print target data consisting of images of an even number of pages (step S110). When determining that the last page is an even page (“Even” in step S109), the controller 68 maintains images represented by the print target data as they are, without executing the processing in step S110.

Subsequently, the controller 68 determines whether the accepted instruction indicates the forward order of printing or the reverse order of printing (step S111). When determining that the accepted instruction indicates the forward order of printing (“Forward” in step S111), the controller 68 selects an image of an N-th page and an image of an (N+1)-th page according to the forward order of printing (step S112).

The controller 68 determines whether the accepted instruction indicates face-down sheet ejection or face-up sheet ejection (step S113). When determining that the accepted instruction indicates face-down sheet ejection (“Down” in step S113), the controller 68 assigns the image of the N-th page and the image of the (N+1)-th page both selected according to the forward order of printing in step S112 as a pair of images for one sheet and allows the image forming apparatus 2 to form the image of the N-th page on the upward facing front side of the sheet and convey the sheet to the sheet conveyance device 3. The controller 68 allows the sheet conveyance device 3 to convey the sheet in the route shown in FIG. 5A or 5B and allows the sheet feeder 1 to return the sheet to the image forming apparatus 2. The controller 68 allows the image forming apparatus 2 to form the image of the (N+1)-th page on the back side of the returned sheet, the back side facing upward (step S114).

The controller 68 allows the image forming apparatus 2 to convey the sheet from the image forming apparatus 2 to the sheet conveyance device 3 again and allows the sheet conveyance device 3 to eject the sheet face-down only through the main conveyance path 31 from the sheet conveyance device 3 as shown in FIG. 3 (step S115). The processing in step S114 and step S115 is executed on all the images represented by the print target data.

When determining that the accepted instruction indicates face-up sheet ejection (“Up” in step S113), the controller 68 assigns the image of the N-th page and the image of the (N+1)-th page both selected according to the forward order of printing in step S112 as a pair of images for one sheet and allows the image forming apparatus 2 to form the image of the (N+1)-th page on the upward facing front side of the sheet and convey the sheet to the sheet conveyance device 3. The controller 68 allows the sheet conveyance device 3 to convey the sheet in the route shown in FIG. 5A or 5B and allows the sheet feeder 1 to return the sheet to the image forming apparatus 2. The controller 68 allows the image forming apparatus 2 to form the image of the N-th page on the back side of the returned sheet, the back side facing upward (step S116).

The controller 68 allows the image forming apparatus 2 to convey the sheet from the image forming apparatus 2 to the sheet conveyance device 3 again and allows the sheet conveyance device 3 to eject the sheet in a state equivalent to the ordinary manner of ejecting sheets face-up only through the main conveyance path 31 as shown in FIG. 3 (step S117). The processing in step S116 and step S117 is executed on all the images represented by the print target data.

When determining that the accepted instruction indicates the reverse order of printing (“Reverse” in step S111), the controller 68 rearranges images represented by the print target data from the original order of printing to the reverse order of printing and selects an image of an N-th page and an image of an (N+1)-th page according to the reverse order of printing (step S118).

The controller 68 determines whether the accepted instruction indicates face-down sheet ejection or face-up sheet ejection (step S113). When determining that the accepted instruction indicates face-down sheet ejection (“Down” in step S113), the controller 68 assigns the image of the N-th page and the image of the (N+1)-th page both selected according to the reverse order of printing in step S118 as a pair of images for one sheet and allows the image forming apparatus 2 to form the image of the N-th page on the upward facing front side of the sheet and convey the sheet to the sheet conveyance device 3. The controller 68 allows the sheet conveyance device 3 to convey the sheet in the route shown in FIG. 5A or 5B and allows the sheet feeder 1 to return the sheet to the image forming apparatus 2. When the sheet is returned to the image forming apparatus 2, the controller 68 allows the image forming apparatus 2 to form the image of the (N+1)-th page on the upward facing back side of the returned sheet (step S114).

The controller 68 allows the image forming apparatus 2 to convey the sheet from the image forming apparatus 2 to the sheet conveyance device 3 again and allows the sheet conveyance device 3 to eject the sheet face-down only through the main conveyance path 31 as shown in FIG. 3 (step S115). The processing in step S114 and step S115 is executed on all the images represented by the print target data.

When determining that the accepted instruction indicates face-up sheet ejection (“Up” in step S113), the controller 68 assigns the image of the N-th page and the image of the (N+1)-th page both selected according to the reverse order of printing in step S118 as a pair of images for one sheet and allows the image forming apparatus 2 to form the image of the (N+1)-th page on the upward facing front side of the sheet and convey the sheet to the sheet conveyance device 3. The controller 68 allows the sheet conveyance device 3 to convey the sheet in the route shown in FIG. 5A or 5B and allows the sheet feeder 1 to return the sheet to the image forming apparatus 2. When the sheet is returned to the image forming apparatus 2, the controller 68 allows the image forming apparatus 2 to form the image of the N-th page on the upward facing back side of the returned sheet (step S116).

The controller 68 allows the image forming apparatus 2 to convey the sheet from the image forming apparatus 2 to the sheet conveyance device 3 again and allows the sheet conveyance device 3 to eject the sheet in a state equivalent to the ordinary manner of ejecting sheets face-up only through the main conveyance path 31 as shown in FIG. 3 (step S117). The processing in step S116 and step S117 is executed on all the images represented by the print target data.

The general ink-jet recording apparatus described previously can appropriately selectively perform: face-down sheet ejection in which sheets are ejected face-down to the sheet output tray; and face-up sheet ejection in which sheets are ejected face-up to the sheet output tray. Furthermore, sheets with both sides recorded can be ejected face-down or face-up.

However, in the case where face-down sheet ejection or face-up sheet ejection is selected after both sides of the sheet has been recorded, if the route of conveyance until the sheet is ejected after both sides of the sheet become wet with ink is long, a sheet jam or the like may be highly likely to occur.

To cope with this, in this embodiment, a sheet with images printed on both sides can be ejected in a state equivalent to the ordinary manner of ejecting sheets face-down or face-up, without conveying the sheet to turn it over as shown in FIG. 4A or 4B, by changing or not changing the order of pages consisting of images to be formed on both sides of the sheet. As a result, according to the elimination of sheet conveyance for turning over the sheet, the likelihood of sheet jams or the like can be reduced. Therefore, in this embodiment, the sheet with images printed on both sides is ejected with each page facing in the same direction as that in the ordinary manner of ejecting sheets face-up in which the first side with an image first formed faces upward, and, thus, the sheet after images are formed on both sides thereof can be quickly ejected.

In the above embodiment, the heat generator 61 applies infrared rays to the top surface of a sheet being conveyed through the main conveyance path 31 to prompt drying of ink adhering to the top surface of the sheet. Therefore, the sheet is shrunk by the application of heat and the image formed on the sheet is also shrunk. In forming images on both sides of the sheet, an image is formed on the back side of the sheet in a state where an image formed on the front side of the sheet becomes shrunk. If no measures are taken against this, the images on the front and back sides of the sheet will be mismatched in size.

As a solution to this problem in forming images on both sides of a sheet, the controller 68 enlarges or reduces the image to be formed on the front side or back side of the sheet by an appropriate enlargement/reduction factor and the enlarged or reduced image is formed on the front or back side of the sheet by the image forming apparatus 2 to match the sizes of images formed on the front and back sides of the sheet. For this purpose, the ratio of expansion/shrinkage of the sheet due to the application of heat is previously measured and the enlargement/reduction factor is previously set based on the measured ratio of expansion/shrinkage.

Although the above embodiment describes an example where an instruction to do single-sided printing or double-sided printing on sheets, eject the sheets face-down or face-up, and specify the order of printing of images of a plurality of pages is input by a user's operation on the operation device 62, the information processing device 71 may instead send the instruction together with print target data to the communication device 65 of the image formation system Sy and the controller 68 may, in accordance with the instruction, allow the image forming apparatus 2 to form images of the pages represented by the print target data on the front sides of sheets or the front and back sides of the sheets and allow the sheet conveyance device 3 to convey and eject the sheets.

Furthermore, in forming images on both sides of a sheet, the information processing device 71 may enlarge or reduce the images to be formed on the front side or back side of the sheet by an appropriate enlargement/reduction factor and send image data representing the enlarged or reduced images to the communication device 65 of the image formation system Sy.

The structures, configurations, and processing of the above embodiment described with reference to FIGS. 1 to 8 are merely illustrative and are not intended to limit the present disclosure to them.

While the present disclosure has been described in detail with reference to the embodiments thereof, it would be apparent to those skilled in the art that various changes and modifications may be made therein within the scope defined by the appended claims.

What is claimed is:

1. An image formation system comprising:
an image forming apparatus that forms an image on an upward facing side of a sheet and then conveys the sheet externally from the image forming apparatus;
a sheet conveyance device that receives the sheet conveyed from the image forming apparatus and that comprises a first mechanism that conveys the received sheet, without turning the sheet over, to eject the sheet from the sheet conveyance device, and a second mechanism that conveys the received sheet back toward the image forming apparatus without turning the sheet over; and
a controller that includes a processor and, in forming images on a front side and a back side of the sheet upon execution of a control program by the processor, conducts sheet conveyance in either one of:
a first conveyance manner to allow the image forming apparatus to form an image of an N-th page (where N is an odd number) on the upward facing front side of the sheet and then form an image of an (N+1)-th page on the upward facing back side of the sheet after being turned over and conveyed back to the image forming apparatus, and allow the sheet, with the front side having the image of the N-th page facing downward, to be conveyed from the image forming apparatus to the sheet conveyance device and ejected through the first mechanism from the sheet conveyance device; and
a second conveyance manner to allow the image forming apparatus to form the image of the (N+1)-th page on the upward facing front side of the sheet and then form the image of the N-th page on the upward facing back side of the sheet after being turned over and conveyed back to the image forming apparatus, and allow the sheet, with the back side having the image of the N-th page facing upward, to be conveyed from the image forming apparatus to the sheet conveyance device and ejected through the first mechanism from the sheet conveyance device.

2. The image formation system according to claim 1,
further comprising a communication device that communicates with an information processing device,
wherein when the communication device receives print target data representing images of a plurality of pages, the controller rearranges the images represented by the print target data from an original order of printing indicated by the print target data to a reverse order of printing reverse to the original order and allows the image forming apparatus to form the images on the front sides and back sides of the sheets in the reverse order of printing.

3. The image formation system according to claim 1,
further comprising an operation device that accepts an input of a user's instruction,
wherein when an instruction to eject the sheet face-down is input to the operation device, the controller conducts the sheet conveyance in the first conveyance manner, and
when an instruction to eject the sheet face-up is input to the operation device, the controller conducts the sheet conveyance in the second conveyance manner.

4. The image formation system according to claim 1, wherein the image forming apparatus forms the image on the sheet using an ink-jet system.

5. The image formation system according to claim 1, wherein the sheet conveyance device further comprises a third mechanism that turns the received sheet over and ejects the turned-over sheet from the sheet conveyance device.

6. The image formation system according to claim 1, further comprising a sheet feeder that turns over the sheet conveyed via the second mechanism from the image forming apparatus and then returns the sheet to the image forming apparatus.
